(19) United States
(12) Patent Application Publication
(10) Pub. No.: US 2009/0226147 A1
(43) Pub. Date: Sep. 10, 2009

(54) Receiving Apparatus

(76) Inventors: Masayoshi MIURA, Yokohama (JP); Takashi Kanemaru, Yokohama (JP); Sadao Tsuruga, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/243,078

(22) Filed: Oct. 1, 2008

(30) Foreign Application Priority Data
Mar. 6, 2008 (JP) 2008-055701

(51) Int. Cl. H04N 5/95

(52) U.S. Cl. 386/85; 386/E05.001

(57) ABSTRACT

A receiving/reproducing apparatus, comprises: a receiver portion for receiving video and/or audio data, time reference information and identification information; a counter portion for giving a timing for decoding of the video and/or audio data with using the time reference information; a clock generator portion for providing a clock signal to the counter portion; a control information generator portion for generating control information for controlling the clock generator portion; a memory portion for memorizing the control information and the identification information; a determining portion for determining on whether the clock signal of the clock generator portion satisfies a condition or not; and a controller portion for memorizing the control information and the identification information into the memory portion, when the determining portion determines to satisfy the condition.

### BACKGROUND OF THE INVENTION

The present invention relates to recording and/or reproducing of data.

In relation to such technical field mentioned above, the following Patent Document discloses therein the structures, for dissolving a problem, i.e., a digital signal cannot be outputted, appropriately, when a clock frequency shifts, being a reference of operation for coding/decoding process, after a predetermined time-period, comprising therein a controller portion, for recording a setup value for controlling the clock frequency of a clock generator portion into a recording portion, any time when decoding video data or audio data, and for controlling the clock generator portion, so that system time information, which is produced by the decoder, comes to be in synchronism with the time information upon receipt of a digital broadcast, with using the setup value, when decoding the data recorded in the recording portion. [Patent Document 1] Japanese Patent Laying-Open No. 2006-352498 (2006).

For the purpose of clearing the explanation, explanation will be made, easily, on the operation of a receiver, when receiving and reproducing a digital broadcast in accordance with MPEG2-TS, for example.

In accordance with MPEG2-TS, in order to reproduce the video and the audio in such a manner that a receiver side intends, a time information value program clock reference (PCR), to be received by the receiver, is transmitted, being multiplexed with.

Firstly, from a transport stream (TS) inputted into the receiver is obtained a program association table (PAT)/program map table (PMT), thereby discriminating a program ID (PID), as an object. The TS packet having the PID discriminated is obtained, and it is divided into the video data, the audio data and PCR.

Next, after setting the PCR obtained in the above to be an initial value of a count value of a system clock counter (STC), the count value is incremented, such that decoding is conducted at the time when a decoding time information (DTS) accompanying each video data is coincident with that count value, and also reproduction (displaying) is conducted at the time when reproduction output time information (PTS) accompanying the audio data is coincident with it.

The STC counter within the MPEG2-TS receiver conducts the counting operation in synchronism with a clock, which is produced by a generator, and the clock frequency thereof is determined to be 27 MHz±30 ppm, according to the MPEG2 regulation. For satisfying this regulation, there is necessity of adjusting the clock frequency, and as a method for that is a PWM (Pulse Width Modulation) control. In the PWM control within a voltage-controlled type crystal oscillator (VCXO), for example, pulse width/distance of an input voltage is controlled, so as to change the voltage value corresponding to an averaged value of a square wave, to be applied to the oscillator; thereby, adjusting the clock frequency.

With the PWM control mentioned above, while comparison is made between the value of PCR, which is received periodically, and the value of the count value of the STC counter, the clock frequency of the oscillator mentioned above is adjusted so that the difference comes to be small and thereby achieving production of the clock signal in synchronism with PCR. Thus, if PCR of the transmitter side (i.e., a broadcast station) satisfies the regulation, then reproduction can be made with the clock frequency, which satisfies the regulation, too, on the receiver side. In case when receiving a plural number of digital broadcast signals, a clock reproduction is conducted with the PWM control, while selecting/refereeing to one signal of them. As was mentioned above, it is possible to achieve a stable reproduction by referring to PCR when receiving the broadcast.

On the other hand, when reproducing from a recording medium, there are cases of applying a reproducing method, in which the distance of transmitting packets is made not constant, intentionally. For example, it is a reproducing method for controlling a data transmission volume and/or a transmission distance from the recording medium (hereinafter, being called “flow controlled reproduction”). In this case, since an input of streams from the recording medium into a decoder is conducted irrespective of the value of PCR, it is impossible to conduct the reproduction through the PWM control by referring to PCR. Accordingly, for example, when conducting the reproduction in accordance with a flow control or under the condition where no expectation of obtaining the correct PCR can be made, the clock reproduction must be made with using a setup value of the clock frequency, which was determined in advance. However, the frequency produced by using the setup value mentioned above shifts from 27 MHz, due to the design error of the circuit or characteristics of the oscillating device or element, for each apparatus or every time when reproducing. If the shift width lies within a range, i.e., 27 MHz±30 ppm, then no problem is generated in the reproduction, however if the shift width is large, and then it goes out from the range determined by the MPEG regulation, a phenomenon occurs, such as, a buffer over or an under flow, for example, during a long time reproduction, therefore bringing about a problem that correct NTSC signal cannot be outputted therefrom or the like.

Also, within a digital broadcast signal recording/reproducing apparatus, having an encoder inside the apparatus, and for outputting a digital signal to external recording equipment, such as, a DVD recorder, for example, in case where a clock frequency, i.e., an operation standard or reference of a coding process, shifts from the range of the regulation, there is brought about a problem that the correct digital signal cannot be outputted, in a similar manner to that when reproducing from the recording medium mentioned above.

Accordingly, when reproducing from the recording medium, or when executing the coding process, there is required a technology for enabling to use the clock signal satisfying the regulation.

The Patent Document 1 mentioned above, discloses therein, in case when decoding the video data or the audio data, a setup value, for controlling the clock frequency of a clock generator portion (hereinafter, being called “a clock control value”), is recording into a recording portion, occasionally, and in particular, when decoding the data, which is recorded on the recording medium, such as, the HDD, within the decoder, then the clock generator portion is controlled in such a manner that a counter counting value produced by a STC counter is synchronized with the PCR when receiving the digital broadcast signal, by using the clock control value mentioned above.

However, with only such technology as the Patent Document 1 mentioned above, an appropriate clock control value is recorded therein, upon basis of an abnormal PCR, in case when receiving the stream, which is abnormal in the PCR, due to generation of an accident of broadcasting or the like, for example. As a result thereof, the inappropriate clock control value is used when reproducing from the recording/reproducing apparatus, and there is brought about a problem that the digital signal cannot be decoded, correctly.

### BRIEF SUMMARY OF THE INVENTION

Then, according to the present invention, an object thereof is to provide an apparatus or the like, for preventing the inappropriate clock control value from being set up when receiving the abnormal stream, and thereby enabling a stable reproduction from a recording medium, with recording/using an appropriate clock control value.

For that purpose, for example, there is provided a device for determining on whether that value is appropriate or not, when renewing the clock control value.

In more details, when decoding the video data and the audio data in the decoder, the clock control value when conducting the PWM control is compared to the clock value(s), which is/are determined up to that time, occasionally, when recording it into the recording portion. As a result of the comparison, if the difference of those has a value exceeding a threshold value, which is determined in advance, then it is determined to be an inappropriate value caused due to the stream abnormality. If it is within the range not exceeding the threshold value, then that value is determined to be appropriate. Only when obtaining the appropriate setup value, recording is conducted on the recording portion. The recording portion holds plural pieces of the clock control values, which are recorded in the past, and records them by referring to the identification information of the stream. When recording, by referring to the identification information of the stream decoded, comparison is made with the identification information, which is owned by the clock control value recorded in the recording portion, and only when one (1) or all of them differs from, the setup value obtained is newly recorded. With doing the above, recording of the inappropriate clock control value is prevented from being recorded, and therefore the appropriate clock control value is recorded.

With such the means mentioned above, for example, it is possible to prevent the inappropriate clock control value from being recorded, which is caused due to receiving of the abnormal stream, and thereby enabling the reproduction from the recording/reproducing apparatus, with using the suitable clock control value obtained in such the manner, with stability.

Moreover, problems, means and effects other than those mentioned above will be explained in the following embodiments, which will be mentioned below.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows the detailed example of a step S406, which will be shown in FIG. 4 below;

FIG. 2 shows an example of the structures of a recording/reproducing apparatus, according to an embodiment of the present invention;

FIG. 3 shows an example of a pulse configuration setting of a STC counter through a PWM control;

FIG. 4 shows an example of processing for obtaining a setup value;

FIG. 5 shows an example of the structures of the recording/reproducing apparatus including an encoder therein;

FIG. 6 shows an example of the structures of the recording/reproducing apparatus including plural numbers of decoder portions therein; and

FIG. 7 shows an example of processing for producing a stable clock when reproducing from a recording medium.

### DETAILED DESCRIPTION OF THE PREFERRED EMBODIMENTS

Hereinafter, embodiments according to the present invention will be fully explained by referring to the attached drawings. However, the present invention should not be restricted to the embodiments, which will be mentioned below.

### Embodiment 1

### Structures of Recording/Reproducing Apparatus

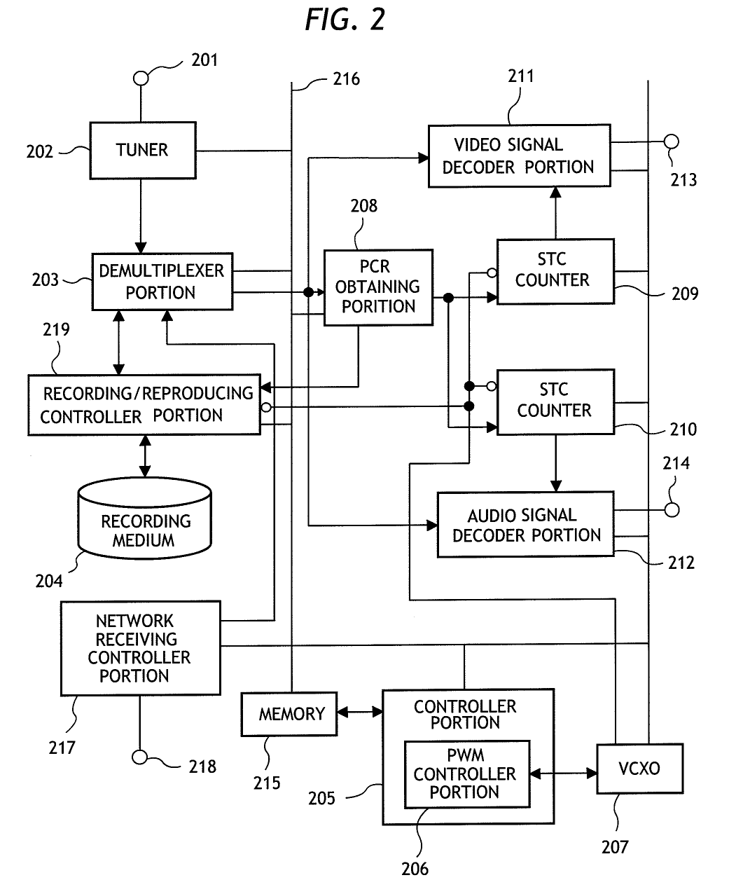

An example of the structures of a recording/reproducing apparatus is shown in FIG. 2. The apparatus comprises therein, an input terminal 201, a tuner 202, a demultiplexer portion 203, a recording medium 204, a controller portion 205, a PWM controller portion 206, a VCXO (Voltage Controlled X'tal (crystal) Oscillator) 207, a PCR obtaining portion 208, a STC counter 209, a STC counter 210, a video signal decoder portion 211, an audio signal decoder portion 212, an output terminal 213, an output terminal 214, a memory 215, a system bus 216, a network receiving processor portion 217, a network input terminal 218 and a recording/reproducing controller portion 219.

The reference numeral 201 depicts the input terminal, to which a digital broadcast signal transmitted with MPEG2-TS format is inputted. The reference numeral 202 depicts the digital tuner block, for receiving/synchronizing the broadcast signal inputted. The reference numeral 203 depicts the demultiplexer portion, which extracts only necessary data from the digital broadcast signal transmitted from the tuner 202, thereby outputting it to the recording/reproducing controller portion 219 (the recording medium 204), or divides data, such as, video, audio, time information, for example, thereby outputting the data to each of blocks of the video signal decoder portion 211, the audio signal decoder portion 212 and the PCR obtaining portion 208. Also, the digital signal transmitted from the recording medium 204 is divided therefrom into the data, i.e., video, audio, time information, in the similar manner, and are outputted to each of blocks, of the video signal decoder portion 211, the audio signal decoder portion 212 and the PCR obtaining portion 208. The reference numeral 204 depicts the recording medium for recording and reproducing the digital data thereon/from. The reference numeral 218 depicts the network input terminal, which is connected to a network, such as, a LAN, etc., and the reference numeral 217 depicts the network receiving processor portion, for receiving the data inputted from the network input terminal 218, and thereby transmitting to the demultiplexer portion 203, as a stream data.

The controller portion 205 controls operation of the present reproducing apparatus. Thus, this receives the PCR from the PCR obtaining portion 208, and compares it with a counting value(s) of the TSC counter 209 and/or 210, so as to transmit a control signal to the PWM controller portion 206, or controls a value, to be set up in the VCXO 207 directly.

The PWM controller portion 206 has a comparator for comparing the PCR of the controller portion 205 and the counting value of the STC counter and a D/A converter for converting the comparison result into DC, etc., thereby building up a PLL (Phase Locked Loop), in combination with the VCXO 207, and it controls the VCXO 207 so as to reduce an error or difference between the PCR and the counting value of the STC counter, when receiving the digital broadcast.

Within the VCXO 207, a clock is generated for operating the STC counters 209 and 210, and it is outputted to the STC counters 209 and 210. Pulse width of the clock is controlled by means of the PWM controller portion 206 or the controller portion 205.

The PCR obtaining portion 208, obtaining the time information PCR obtainable from the demultiplexer portion 203, sets it to the counting value of the STC counters 209 and 210 in the stage thereafter, and at the same time, transmits it to the controller portion 205 through the system bus 216.

The STC counter 209 sets the PCR value supplied from the PCR obtaining portion 208, as the counting value thereof, and counts up the counting value by referring to the clock, which is generated by the VCXO 207. And, it also supplied the counting value to the video signal decoder portion 211, occasionally.

The STC counter 210 counts up the counting value, similar to the STC counter 209 mentioned above, and supplies it to the audio signal decoder portion 212.

The video signal decoder portion 211 decodes/outputs the video signal, which is transmitted from the demultiplexer 203. It executes the decoding at a timing when the counting value, which is received from the STC counter 209, is coincident with the time information DTS, which is attached with the video signal, and outputs the video signal decoded at a timing when it is coincident with the time information PTS.

The audio signal decoder portion 212 decodes/outputs the video signal, which is transmitted from the demultiplexer 203. It executes decoding in synchronism with the timing when the counting value of the STC counter 210 is coincident with the time information DTS attached with the audio signal, and outputs it to the output terminal 214. The reference numeral 213 depicts the output terminal for outputting the video data decoded. The reference numeral 214 depicts the output terminal for outputting the audio data decoded. The reference numeral 215 depicts the non-volatile memory device for recording the setup values, to be used when executing the PWM control upon the VCXO 207, etc. The reference numeral 216 depicts the system bus for the controller portion 205 to communicate commands and data with each of the blocks.

The recording/reproducing controller portion 219 executes data processing into a format suitable for recording and/or reproducing, or control of the recording medium 204. To the recording/reproducing controller portion 219 are inputted the clock from the VCXO 207 and the PCR from the PCR obtaining portion 208, wherein it is possible to obtain the time information upon basis of the PCR through the PLL owned therein. The recording/reproducing controller portion 219, when recording the stream data on the recording medium 204, adds the time information (i.e., the time stamp) based on the PCR to the packet building up the data, respectively.

With the structures mentioned above, in the recording/reproducing apparatus according to the present embodiment, the broadcast signal inputted from the input terminal 201, the digital signal recorded on the recording medium 204, and the digital signal inputted from the network input terminal 218 are outputted, in synchronism with the video and audio.

When receiving the digital broadcast, the STC counter is operated with stability, through the PWM control, which will be explained below.

### Explanation of PWM Control

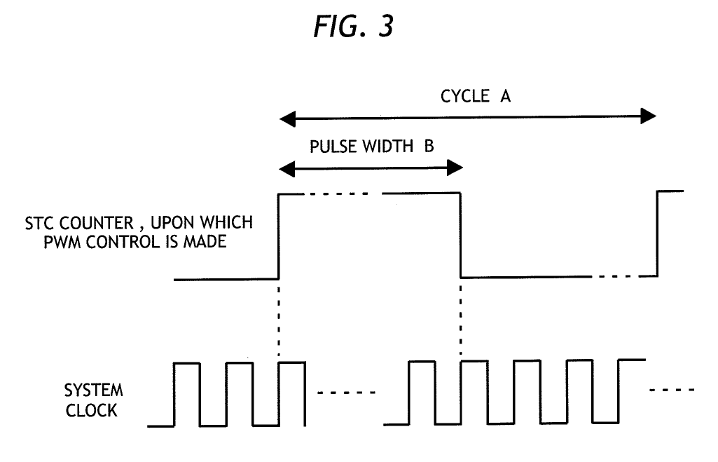

With the PWM control portion 206, it is possible to control the pulse frequency (“A” in FIG. 3) or/and the pulse width (“B” in FIG. 3) of the VCXO 207, by a multiple of the system clock, which is generated by the oscillation element, such as, shown in FIG. 3, for example. In this apparatus, when receiving the digital broadcast, the STC counters 209 and 210 are controlled by means of the PWM controller portion 206. After completing the tuning or channel selection, the PCR obtaining portion 208 transmits the PCR to the controller portion 205, and the STC counter(s) 209 and/or 210 transmit(s) the counting value to the controller portion 205. The controller portion 205 compares the PCR with the counting value, so as to determine a size relationship of those values, and sends the control signal to the PWM controller portion 206. The PWM controller portion 206 changes the setup value in such a manner that the error or difference between the counting value and the PCR comes to be small, depending on the control signal mentioned above. The reason of calling the setup value herein is to mean one (1) or plural numbers of numeral values, enabling to determine the output of the VCXO 207 to be unique, such as, the voltage value to be added to the VCXO 207, or the frequency information, etc., for example.

In case where PCR>the counting value of the STC counter, as the result of comparison, the PWM controller portion 206 controls so that the output pulse width of the VCXO 207 comes to short. On the contrary, where PCR<the counting value of the STC counter, as the result of comparison, the PWM controller portion 206 controls so that the output pulse width of the VCXO 207 comes to long. After repeating the operation mentioned above, for a predetermined time, the STC counters 209 and 210 operate, with stability, at the frequency in synchronism with the PCR received. The setup value when the frequency is stabilized within the region, which is determined by the MPEG regulation, is that, which can be considered to be appropriate when conducting the clock reproducing and the recording on the recording medium 204, and this may be called “control information”.

### Use of Setup Value

While recording the appropriate setup value, which can be obtained with the method mentioned above, into a memory 215, the clock reproduction can be stabilized, with controlling the VCXO 207 by use of this setup value, in particular, when conducting the reproduction without referring to the PCR, such as, when reproducing the digital signal recorded on the recording medium 204, etc.

For example, this setup value should no be fixed after it is determined once, but it is controlled within the controller portion 205, to be renewed and recorded, occasionally, at an optical or suitable setup value. In more details, every time when receiving the broadcast, the controller portion 205 obtains the setup value for stabilizing the frequency of the VCXO 207, and renews the setup value, which is recorded in the memory 215 until now, by the setup value obtained newly.

In particular, with the present embodiment, there is provided a device for determining on whether the setup value is appropriate or not, by which the renewal is made. When recording the setup value, comparison is made between the setup value, which is recorded in the memory 215 until now, and the setup value, which is obtained newly, and if the value of the difference between those values exceeds a threshold value, which is determined in advance, then it is determined to be an inappropriate setup value due to abnormality of the stream. If the difference has a value not exceeding the threshold value, that setup value is determined to be an appropriate one. With the threshold value, it may be a value of such a degree that can be allowed experimentally, including an error therein, and it is determined upon a criterion, i.e., a clear abnormal stream can be discriminated thereupon. For example, as the threshold value may be applied the control voltage value, which may be determined not to exceed the range (i.e., ±30 ppm), which is determined by the MPEG regulation as the rated value for the oscillation element. In addition to this method, for example, the information for discriminating a broadcasting station or an attending program into the memory 215, together with the setup value. With doing this, even if the stream abnormality occurs on a certain broadcast, due to broadcasting accident or the like, for example, no abnormal broadcast will be received, continuously, and therefore, the inappropriate setup value will not recorded/used. As identification information may be used the data, including therein the program information, which is called “SI (Service Information)”, in particular, when receiving the MPEG2-TS. As an example, the following information can be use, which are included within the SI information: the information for discriminating the broadcast station, being called “TS_ID”, the information for discriminating the channel, being called “Service_ID”, and the information for discriminating the kind of the broadcast wave, being called “Network_ID”, etc. This is recorded by referring to the setup value mentioned above. In the embodiment, which will be mentioned blow, the explanation will be proceeded, with using the “TS_ID” as the identification information; however, there may be used the identification information other than “TS_ID”.

### Example of Processing Steps

An example of the processing steps (or may be called only “steps”) will be shown, mainly, for the controller portion 205, to obtain the setup value, when it operates with stability upon receipt of the digital broadcast, below.

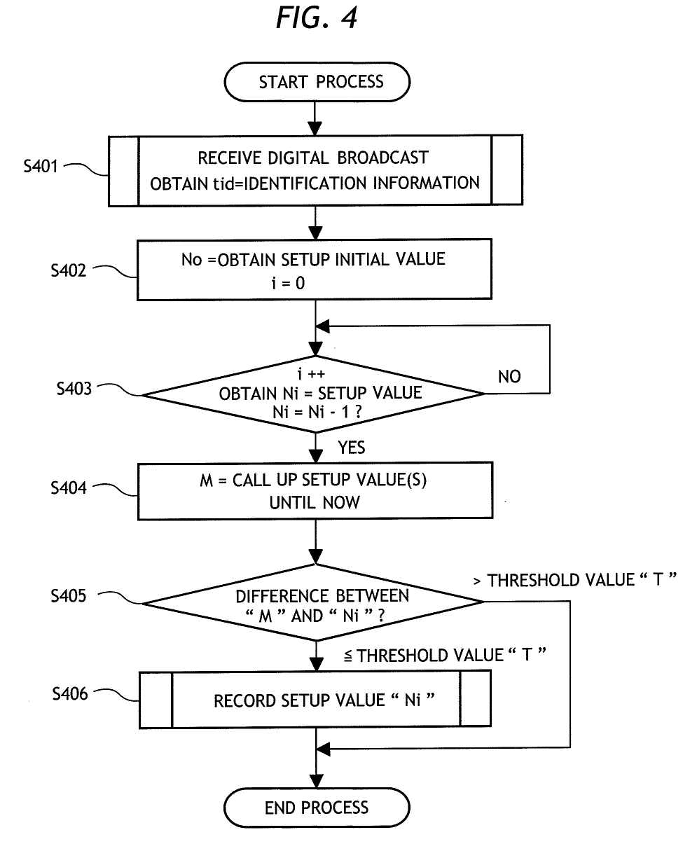

FIG. 4 shows an example of the operation for obtaining the setup value when receiving the digital broadcast. In a step (hereinafter, it will be abbreviated by “S”) 401, the digital broadcast is received, so as to obtain/hold the identification information that the apparatus is receiving (for example, TS_ID, indicative of the broadcast station), and the process shifts to S402.

In S402, determination is made on an initial setup value to be applied to the VCXO 207, and the process shifts into S403. Hereinafter, the renewal process is conducted on the setup value, every time when receiving the PCR by the operation of the PLL circuit, which is made up with the PWM controller portion 206 and the VCXO 207, and finally, it is possible to obtain a system clock, which is small in the phase difference between the PCR.

In S403, a comparison process is conducted by means of a loop. After shifting into S403, a control-use setup value is obtained, and further after waiting for time, in which the clock frequency can be considered to be stable, from starting to receive the broadcast, the control-use setup value is obtained, again, to be compared with the value, which is obtained by the previous loop. However, upon this waiting, it is possible to count the time itself (such as, seconds, for example), or count a number of times of receiving the PCR. If the result is equal to (if there is the difference, but it is within a range to determine to be equal), it is determined that the stable system clock can be obtained, then the process shifts into S404. If the result is different from (i.e., if the difference is outside the range to determine to be equal), the process shifts into a loop for repeating the S403, again.

In S404, the controller portion 205 calls up the setup values up to the present time (being called “M”, provisionally) from the memory 215, and the process shifts into S405. However, until when the setup value is recorded, firstly, upon receipt of the broadcast, it is assumed that the initial value is called up, which is previously recorded in the memory 215. In S405, comparison is made between the M, which is called up in S404, and the setup value, which is obtained in S403 (being called “N”, provisionally). When the difference is smaller than the threshold value, which is determined in advance, then the process shifts into S406, while considering that the “N” is an appropriate setup value. When the difference is larger than the threshold value, the process is ended, but without recording thereof, while considering that the “N” is the abnormal setup value caused due to the stream abnormality.

In S406, the setup value “N” obtained is recorded into the memory 215.

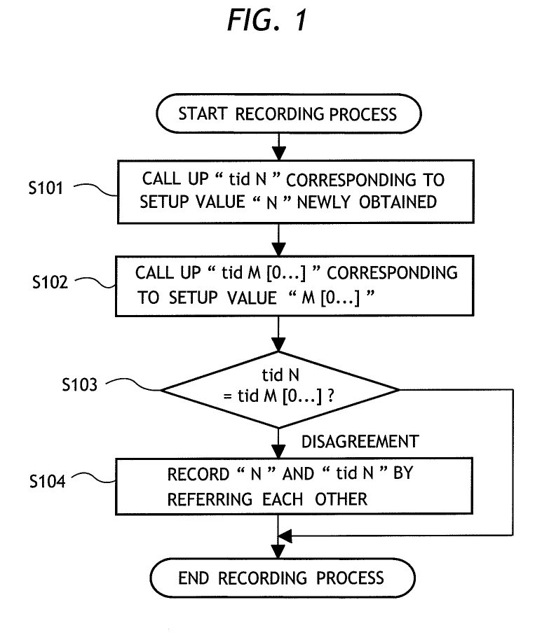

As the detailed example of S405, an example of the method is shown in FIG. 1, for recording the appropriate setup value into the memory with using the identification information. In the memory 215 are held a plural number of the setup values, which are recorded up to the present, within a setup value history table.

In S101, the setup value “N”, which is called up in S403, and the identification information “TS_ID (hereinafter, being called “tidN”), which is obtained when starting the receiving, and then the process shifts into S102.

In S102, the past setup value “M” and the identification information “TS_ID (hereinafter, being called “tidM”), which is recorded with reference to that, are called up, and the process shifts into S103.

In S103, comparison is made between the “tidN” of the presently received digital broadcast, which is obtained by the loop in S101, and the “tidN”, which is owned by each of the setup values in the history table. Comparing to all “tidm”s in the table, and if there is disagreement, the process shifts into S104, and the setup value “N” and the “tidN” are recorded into the memory 215, and the process is ended.

However, as the condition for division in S103, there can be listed up a method for conducting the recording if the disagreement is any one among the “tidN”s and the “tidM”s, and further other than that, a method for conducting the recording only when all are disagreed with. With the present embodiment, there is an upper limit for the setup values, which can be memorized in the table, and then it is presumed that the setup values will be deleted in the order of the oldness thereof. This upper limit value may be lower than the number of the broadcast stations. If not fitting to this division condition in S103, then the process is ended, but without conducting the recording.

When reproducing the digital signal recorded on the recording medium 204, it is possible to conduct the clock reproduction, with stability, by controlling the VCXO 207 with using the setup value, which is recorded in the memory 215 through the method mentioned above. With the setup value(s) to be used at this time, there may be listed up the followings: for example, a method of using only one (1) setup value recorded, or a method of using a value, which can be obtained from an average of the plural numbers of setup values “M”.

### Embodiment 2

In an embodiment 2, when recording the setup value into the memory, the setup values, each being appropriate for each “TS_ID” (in general, for each broadcast station), are separated and recorded in the setup value history tables, each being different from each other, in the memory 215. Within the memory 215 is provided the setup value history table, for each “TS_ID”, and in each table are held plural pieces of the setup values “M”, which are recorded up to now. If exceeding an upper limit of holding number of the table, then for example, the oldest setup value “M” is erased and is renewed with a new setup value “M”.

When reproducing the digital signal recorded on the recording medium 204, the identification information TS_ID is obtained, which is owned by the digital signal of the reproduction target, and the clock reproduction is conducted with using the setup value from the corresponding setup value history table. With this method, it is possible to achieve the stable clock reproduction fitting to an encoder accuracy of the broadcast station and the kind of the broadcast wave. With the setup value(s) to be used at this time, there may be listed up the followings: for example, a method of using only one (1) setup value recorded, or a method of using a value, which can be obtained from an average of the plural numbers of setup values “M”.

### Embodiment 3

Within an embodiment 3, a PWM control value is obtained and, periodically, to be accumulated, during the time when receiving a certain program.

In case where a plural number of PWM control values are accumulated when completing the receiving of a program, an averaged value of those is calculated, as the setup value to be recorded in the memory 215. With applying the method of the embodiment 1 or 2, the controller portion 205 records the setup value and the identification information corresponding thereto into the memory 215, and ends the process.

Also, it is possible to make an observation fitting to an arrival distance of the PCR. With this, it is possible for the receiver to detect that a defect occurs in the receiving, when the PCR does not arrive within the time-period, which is determined by the regulation, such as, when a packet is failed, which builds up the stream, because of a broadcasting defect caused due to radio fault, such as, jamming, etc. When detecting the defect in the receiving, the PWM control value is not accumulated, or the setup value is not recorded.

### Embodiment 4

Within an embodiment 4, explanation will be made on the case of dealing with an ill influence due to aging or secular deterioration of the oscillation element.

In case where the receiver is not used for a long time, the oscillation element receives the ill influenced due to the secular deterioration thereof, and there is a possibility that a large difference comes out between the setup value, which is recorded the last time, and the appropriate setup value at the time when using it again. If the difference due to the deterioration is equal or larger than a threshold value, it is considered to be an abnormal value, and therefore, the setup value cannot be recorded, even if it is the appropriate value. As a countermeasure for that, there is a method of changing the threshold value depending on the largeness of the time difference, comparing the previous date and the present date, while recording the date when recording the setup value the last time, into the non-volatile memory device, such as, the memory 215 or the recording medium 204, etc. Thus, the threshold value had a value, continuously increasing depending on the length of the time passing from the date when it is used the last time, so that the appropriate setup value, based on the clock aged or secularly deteriorated, is not considered to be the abnormal value, and thereby enabling to record the setup value, appropriately, even when it is not used for a long time.

### Embodiment 5

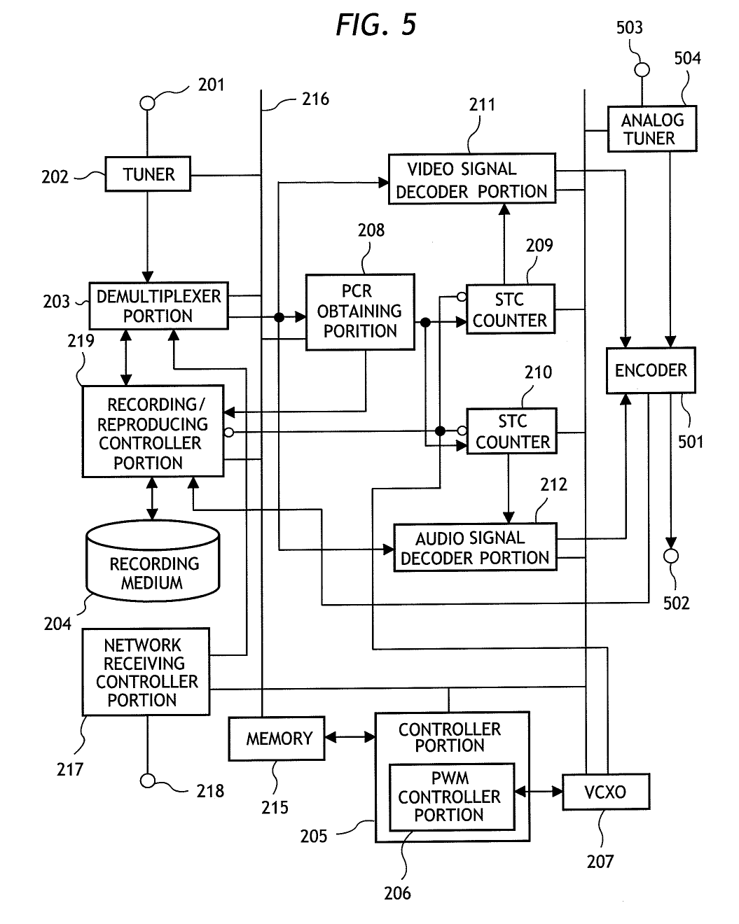

With an embodiment 5, an example of the structures of the recording/reproducing apparatus will be shown in FIG. 5, which is obtained by adding an encoder to the structures shown in FIG. 2.

An encoder 501, inputting the video signal decoded within the audio signal video signal decoder portion 211 and the audio signal decoded within the audio signal decoder portion 212, conducts the decoding thereon, upon basis of the clock signal, which is outputted from the VCXO 207, and thereby outputting them to an output terminal 502, or outputting them to the recording/reproducing controller portion 219 (the recording medium 204).

The output terminal 502 is connected with external equipment, such as, the DVD recorder, for example, i.e., it is the terminal for outputting the data, which is coded within the encoder 501.

An analog signal input terminal 503 is the terminal for inputting a signal of the analog broadcast, and an analog tuner 504 is a tuner block for receiving/tuning the signal inputted from that analog signal input terminal 503.

In the example of the structures shown in FIG. 5, also when conducting the encoding within the encoder 501, it is possible to obtain the stable coding operation, by controlling the VCXO 207 with using the stable setup value, which can be obtained by the embodiments mentioned above, in the similar manner to the embodiments 1 to 3. The method for recording and reading out the setup value is similar to that of the embodiments 1 to 3.

Also, when recording the analog broadcast, the signal inputted from the analog signal input terminal 503 is encoded within the encoder, in the form of digital signal, and it is recorded on the recording medium 204 through the recording/reproducing apparatus 219, in the stream thereof. In this instance, when the recording/reproducing apparatus 219 adds the time information to the digital signal encoded, it is possible to add an appropriate time information to the data to be recorded onto the recording medium 204, by producing the time information upon basis of the frequency of the VCXO 207, being controller by the appropriate setup value, which is obtained from the embodiments mentioned above.

### Embodiment 6

In an embodiment 6, explanation will be made on the case where there are plural numbers of decoder portions, including the PCR obtaining portion 208 therein.

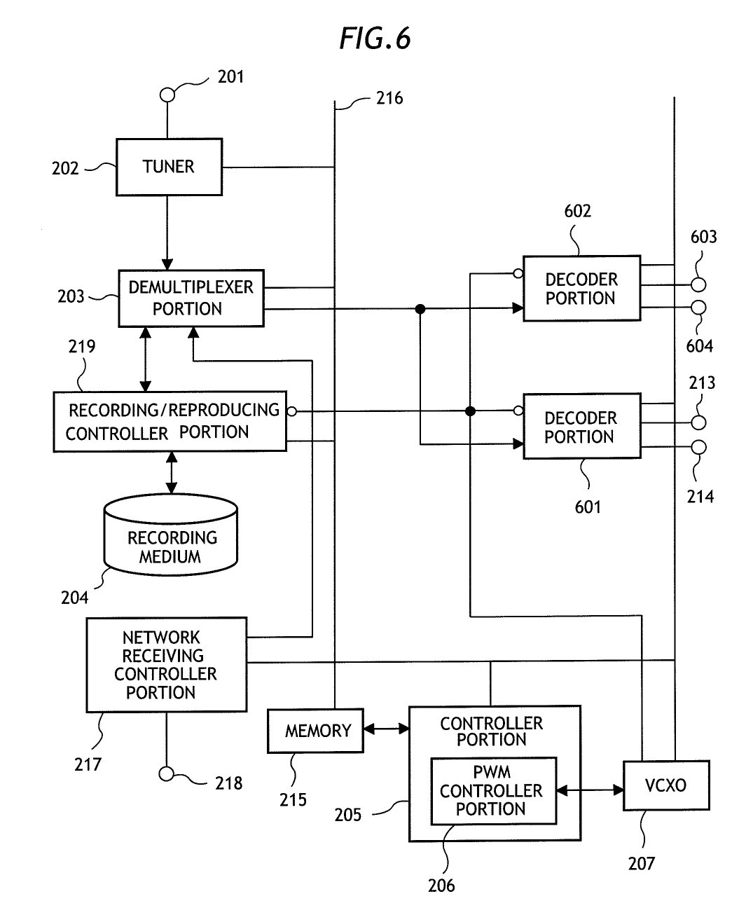

FIG. 6 shows therein a digital broadcast recording/reproducing apparatus, which is obtained by adding a decoder portion 601, including the PCR obtaining portion 208, the video signal decoder portion 211 and the audio signal decoder portion 212 shown in FIG. 2, a decoder portion 602 having the same structures to the decoder portion 601, and the structures for outputting the video signal decoded to an output terminal 603 and for outputting the audio signal decoded to an output terminal 604.

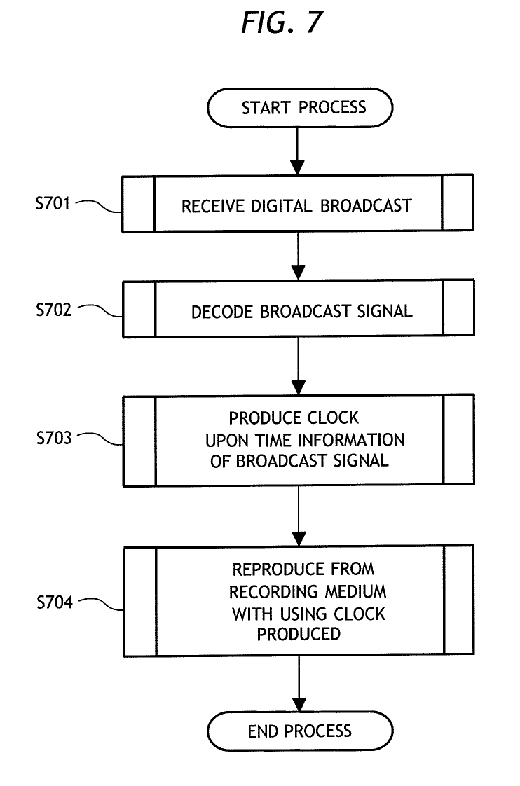

Steps are shown in FIG. 7, for producing the stable clock in this apparatus, when reproducing from the recording medium 204.

In S701 is obtained the identification information of the program, to be reproduced from the recording medium 204, within the tuner 201, thereby receiving the program of the channel having the identification information same to that program, and the process shifts into S702. In S702, decoding is conducted on the signal from the tuner 201, within the decoder portion 602, and the process shifts into S703. In S703, the PWM control is conducted with using the PCR and the STC counting value, which are obtained from the decoder portion 602, and the signal of the VCXO 207 obtained is inputted to the decoder portion 602, then the process shifts into S704. In S704, the decoder portion 601 conducts the reproduction from the recording medium 204 with using the clock signal, which is obtained from in the step S703.

With the operations explained in the above, it is possible to reproduce the stable clock when conducting the reproduction from the recording medium 204, in the similar manner to the case when recording the setup value mentioned above in the memory 215.

### Embodiment 7

In an embodiment 7, explanation will be made on the case when receiving the stream data, not only through the broadcast, but also through the network.

In the example of the structures shown in FIG. 2, in particular, when reproducing the stream data inputted from the network input terminal 217, because of possibility that the PCR does not arrive within the time determined by the regulation, or that the data transmission is broken due to overload of the network traffic, etc., it is difficult to conduct the clock reproduction by referring to the PCR. Accordingly, it is to apply the reproduction method of controlling the data to be transmitted, variably. In this instance, the stable clock reproduction is achieved with using the appropriate setup value, which is obtained by the method shown in the embodiments mentioned above, but not using the identification information.

Also in case when receiving the data from the network, but not in the form of the MPEG2-TS, if the correct time information to be a reference for the decoding can be obtained from the communication protocol to be used, at that instance, in the similar manner to PCR, then it is possible to conduct the clock reproduction optimized for that network, by determining the setup value with using that information.

With the embodiments 1 to 7 mentioned above, the recording medium should not be limited to, for example, the HDD, the DVD, the Blu-ray Disk, etc., in the kind thereof, as far as it is the type for receiving the digital broadcast and recording/reproducing.

Also, with the embodiments 1 to 7 mentioned above, the recording medium of the setup value detected should not restricted to the memory 215, but it may be recorded in any recording medium, such as, the recording medium 204, for example, as far as it is the non-volatile memory.

Also, with the embodiments 1 to 7 mentioned above, the explanation was given on the MPEG2-TS, however the present invention should not be restricted to this format, but may be applied to any one of the formats of transmitting the reference value, cyclically, for the clock reproduction.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A receiving/reproducing apparatus, comprising:
a receiver portion, which is configured to receive video and/or audio data, time reference information and identification information;
a counter portion, which is configured to give a timing for decoding of the video and/or audio data with using said time reference information;
a clock generator portion, which is configured to provide a clock signal to said counter portion;
a control information generator portion, which is configured to generate control information for controlling said clock generator portion;
a memory portion, which is configured to memorize said control information and said identification information;
a determining portion, which is configured to determine on whether the clock signal of said clock generator portion satisfies a condition or not; and
a controller portion, which is configured to memorize said control information and said identification information into said memory portion, when said determining portion determines to satisfy the condition.

2. The receiving/reproducing apparatus, as described in the claim 1, wherein said controller portion compares the identification information received with the identification information, which is already recorded in said memory, thereby determining on whether said control information and said identification information should be memorized.

3. The receiving/reproducing apparatus, as described in the claim 1, wherein said controller portion obtains the control information of the identification information corresponding to said receive video and/or audio data, when reproducing the receive video and/or audio data.
